(19) United States
(12) Patent Application Publication
(10) Pub. No.: US 2008/0314468 A1
(43) Pub. Date: Dec. 25, 2008

(54) Cap or Plate With Electronic Or Magnetic Marker

(76) Inventor: Jon Houghton, Rochester Hills, MI (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/144,333

(22) Filed: Jun. 23, 2008

Related U.S. Application Data
(60) Provisional application No. 60/945,751, filed on Jun. 22, 2007.

(51) Int. Cl. F16L 55/10; B65D 41/04

(52) U.S. Cl. 138/89; 220/288; 138/104; 138/96 R

(57) ABSTRACT

A cap or plate configured to be coupled with an electronic or magnetic marker and the end of a pipe. The cap may comprise a top portion with a first diameter, a second portion with a second diameter, and a top surface configured for coupling with an electronic or magnetic marker. The first diameter may be approximately equal to an outer diameter of a first pipe, and the second diameter may be approximately equal to an outer diameter of a second pipe. The plate may have a diameter that is greater than the inner diameter of a pipe. The plate may be secured to the pipe such as with a conventional cap, or a threaded plug. When the cap or plate is coupled with a pipe, the electronic or magnetic marker may be used to locate and/or identify a pipe.

The present application claims priority to U.S. Provisional Application No. 60/945,751 filed Jun. 22, 2007, the contents of which are incorporated herein by reference in their entirety.

### BACKGROUND

The exemplary embodiments described herein relate generally to a cap or plate for use with a pipe, and more particularly to a cap or plate that is configured to receive an electronic or magnetic marker.

Electronic and magnetic markers (e.g., burial markers) may be used to identify the location of a pipe (e.g., an underground pipe). Some electronic markers may further identify whether a pipe is a water pipe, sewer pipe, gas pipe, electric pipe, etc. A locator tool may be used in combination with the electronic or magnetic marker—for example, the locator tool may transmit a signal to the marker, which can then be reflected back to the locator to indicate the exact location and/or type of pipe, such as with a visual reading and a tone.

Exemplary electronic markers may include a radio frequency identification device (RFID). The electronic marker may generally comprise a disc encapsulated by polypropylene. Exemplary electronic markers may include those commercially available from the 3M Company.

### SUMMARY

Based on the foregoing, there remains a need for a device to couple an electronic or magnetic marker to a pipe (e.g., underground pipes) without modification to existing pipes. In addition, there remains a need for a device that is removable from a pipe without modification or damage to existing pipes.

It is therefore a feature of the embodiments to provide a cap assembly for placement over an end of at least a first pipe or a second pipe. The cap assembly may have a cap including a first portion having a first inner diameter that is approximately equal to the outer diameter of the first pipe, a second portion having a second inner diameter that is approximately equal to an outer diameter of the second pipe, and a top surface configured for coupling with an electronic or magnetic marker.

It is also a feature of the embodiments to provide an assembly for coupling an electronic or magnetic marker with a pipe. The assembly comprises a plate having an outer diameter that is greater than an inner diameter of the pipe, and an electronic or magnetic marker coupled with the plate using ultrasonic welding or heat staking.

It is yet another feature of the embodiments to provide a method for coupling an electronic or magnetic marker to a pipe. The method includes providing a cap including at least a top portion having a first inner diameter, a bottom portion having a second inner diameter, and an upper surface adjacent to the top portion of the cap. The method further includes welding or heat-staking an electronic or magnetic marker to the upper surface of the cap, and placing the cap on the end of a pipe having an outer diameter.

It is also a feature of the embodiments to provide a method for coupling an electronic or magnetic marker to a pipe. This method includes providing a plate having an outer diameter that is greater than an inner diameter of a pipe; welding or heat staking an electronic or magnetic marker to one surface of the plate; and placing the plate adjacent an end of said pipe.

Additional features, advantages, and embodiments of the invention may be set forth or apparent from consideration of the following detailed description, drawings, and claims. Moreover, it is to be understood that both the foregoing summary and the following detailed description are exemplary and intended to provide further explanation without limiting the scope of the invention as claimed.

### BRIEF DESCRIPTION OF THE DRAWINGS

The accompanying drawings, which are included to provide a further understanding of the embodiments and are incorporated into and constitute a part of this specification, illustrate exemplary embodiments and together with the detailed description serve to explain the principles of the invention. In the drawings:

FIG. 1 is a perspective view of a cap assembly in accordance with an exemplary embodiment described herein.

FIG. 2 is a cross-sectional view of a cap assembly, as taken across A-A of FIG. 1, in accordance with an exemplary embodiment described herein.

FIG. 3 is a cross-sectional view of a cap assembly in accordance with an exemplary embodiment described herein.

FIG. 4 is a cross-sectional view of a plate assembly in accordance with an exemplary embodiment described herein.

FIG. 5 is a cross-sectional view of a plate assembly in accordance with an exemplary embodiment described herein.

FIG. 6 is a top view of a plate assembly in accordance with an exemplary embodiment described herein

FIG. 7 is a cross-sectional view of a plate assembly, as taken across B-B of FIG. 6, in accordance with an exemplary embodiment described herein.

FIG. 8 is a perspective view of the top of a plate assembly in accordance with an exemplary embodiment described herein.

FIG. 9 is a perspective view of the bottom of a plate assembly in accordance with an exemplary embodiment described herein.

FIG. 10 is an exploded perspective view of a plate assembly, as it may be assembled with a threaded pipe and plug, in accordance with an exemplary embodiment described herein.

### DETAILED DESCRIPTION OF THE EXEMPLARY EMBODIMENTS

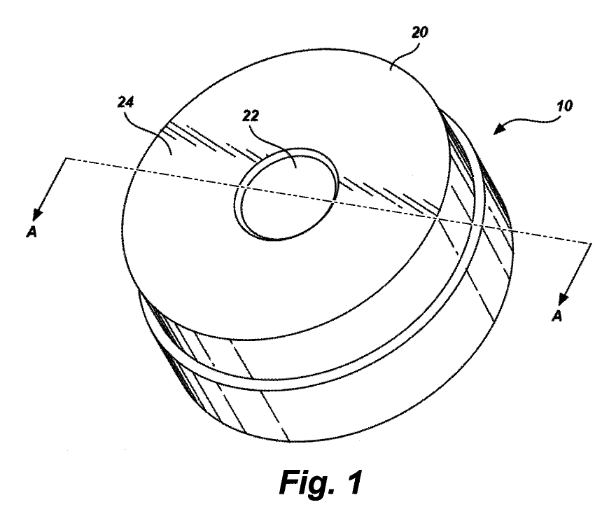

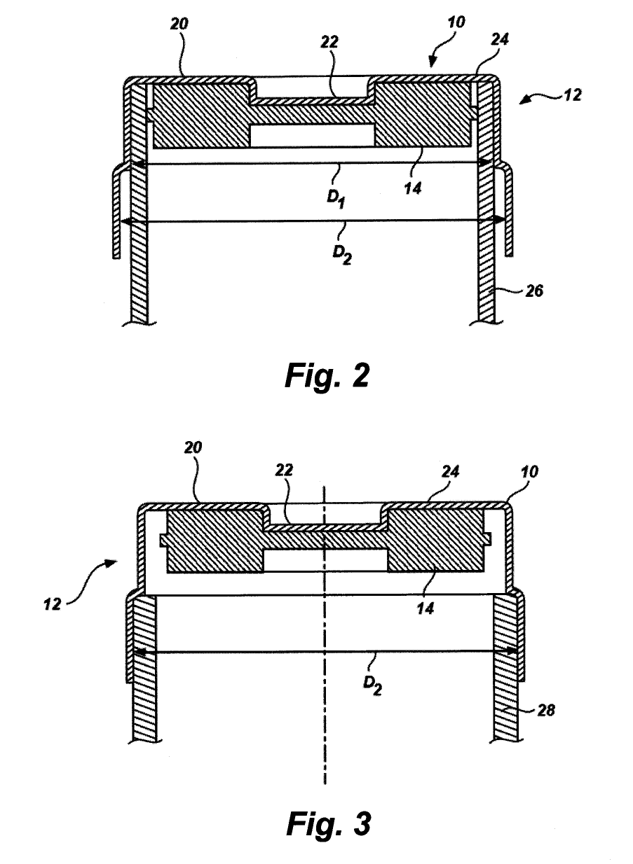

Referring now to the drawings wherein like reference numerals designate corresponding parts throughout the several views, FIG. 1 illustrates a perspective view of a cap 10 according to exemplary embodiments described herein, and FIGS. 2-3 illustrate cross-sectional views of a cap assembly 12, according to exemplary embodiments described herein. Referring now to FIG. 2, in an exemplary embodiment, cap assembly 12 may comprise a cap 10 and a marker 14.

In exemplary embodiments, marker 14 may comprise any electronic marker or magnetic marker generally known by those of ordinary skill in the art, or later developed for this purpose. For example, an exemplary electronic marker 14 may be generally disc-shaped and may be encapsulated by polypropylene or other polymer. Exemplary electronic markers 14 may include markers commercially available from the 3M Company. Electronic marker 14 may include a radio frequency identification device (RFID). Exemplary electronic markers 14 may be located near and/or in underground pipes so as to help identify whether a pipe is a water pipe, sewer pipe, gas pipe, electric pipe, etc. A locator tool may be used in combination with the marker 14. For example, the locator tool may transmits=a signal to the electronic marker 14, which then may reflect the signal back to the locator to indicate the exact location and/or type of pipe, such as with a visual reading and/or tone.

In various exemplary embodiments, marker 14 may be coupled with cap 10 to form cap assembly 12. In exemplary embodiments, cap 10 may comprise a polymer, such as, for example, polyethylene, polypropylene, polyvinyl chloride (PVC), or acrylonitrile butadiene styrene (ABS). However, it is understood that any number of polymers or other materials may be used for cap 10 and remain within the spirit and scope of the embodiments. In exemplary embodiments, marker 14 may be coupled to the underside of cap 10. Ultrasonic welding or heat staking may be used to couple marker 14 to cap 10, however it is understood that any number of suitable methods may be used to couple marker 14 and cap 10.

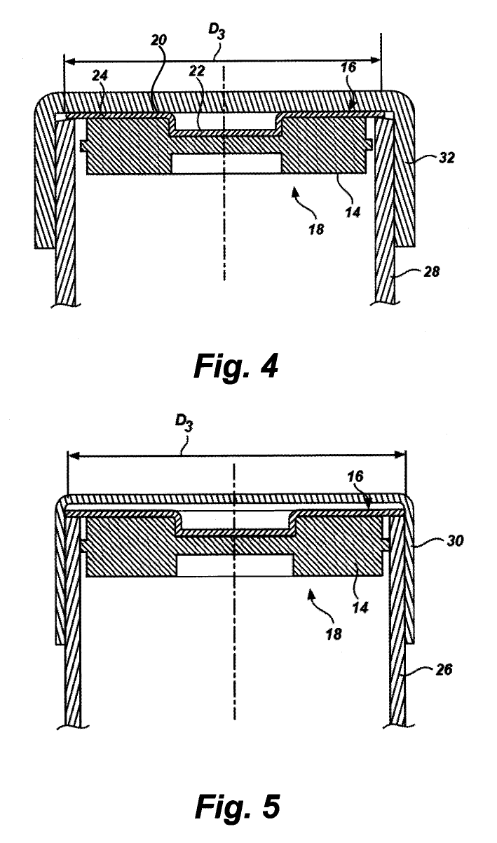

Referring now to FIGS. 4-5, in various exemplary embodiments, marker 14 may be coupled with plate 16 to form plate assembly 18. In exemplary embodiments, plate 16 may comprise a polymer, such as, for example, polyethylene, polypropylene, polyvinyl chloride (PVC), or acrylonitrile butadiene styrene (ABS). However, it is understood that any number of polymers or other materials may be used for plate 16 and remain within the spirit and scope of the embodiments. In exemplary embodiments, marker 14 may be coupled to the underside of plate 16. Ultrasonic welding or heat staking may be used to couple marker 14 to plate 16. It is understood that any number of methods may be used to couple marker 14 and plate 16.

In various embodiments, a top surface 20 of cap 10 or plate 16 may have the same contour as marker 14. For example, in an embodiment in which the marker 14 is disc shaped and has a central depression, cap 10 or plate 16 may have a center circular portion 22 of top surface 20 that may be of a lower height than the surrounding annular portion 24 of the top surface 20 in order to mirror and/or match the contour of marker 14. This configuration may improve bonding of cap 10 or plate 16 to marker 14.

In exemplary embodiments, cap 10 may have a first inner diameter D₁ at top surface 20 and a top portion of cap 10. In exemplary embodiments, first inner diameter D₁ may be approximately equal in diameter to the outer diameter of a first pipe 26. In exemplary embodiments, first pipe 26 may be, for example, a standard sewer pipe. Although a sewer pipe is specifically mentioned and described, it is understood that any of a number of pipes may be used in connection with cap 10 without departing from the spirit and scope of the embodiments.

In exemplary embodiments cap 10 may be configured to fit over a first pipe 26, as illustrated for example in FIG. 2. For example, first inner diameter D₁ may be designed to provide an interference fit over a riser pipe, without the need for a fitting to be attached and/or connected to the riser pipe. In some embodiments, cap 10 may be configured for use with 3″, 4″, 6″, and 8″ pipe. Although these dimensions are mentioned in detail, it is understood that any of various dimensions may be used and remain within the spirit and scope of the embodiments.

In exemplary embodiments, first inner diameter D₁ may be larger than the diameter of marker 14. Accordingly, when cap 10 is placed over a pipe 26 as shown in FIG. 2, marker 14 may be disposed within pipe 26.

In exemplary embodiments, cap 10 may have multiple portions, each with a different inner diameters, so that one cap 10 may accommodate a variety of pipe sizes. For example, as shown in FIGS. 2 and 3, cap 10 may have a second inner diameter D₂ at a height of cap 10 that is offset from (i.e., lower than) top surface 20 and top portion of cap 10. Accordingly, a second portion of cap 10 may have a second inner diameter D₂ that is larger than first inner diameter D₁. In various embodiments, cap 10 may further comprise one or more additional portions, each portion having a different diameter suitable for coupling with other size pipes.

In an exemplary embodiment illustrated in FIGS. 2 and 3, cap 10 may have a first portion having a first inner diameter D₁ that is approximately equal in diameter to the outer diameter of a first pipe 26, and a second portion having a second inner diameter D₂ that is greater than D₁ and approximately equal in diameter to the outer diameter of a second pipe 28. When cap 10 is fit over first pipe 26, first portion may engage the first pipe 26 about its outer surface, while the second portion with second inner diameter D₂ may not engage the first pipe 26, as illustrated in FIG. 2.

In an exemplary embodiment, cap 10 may be configured with a second inner diameter D₂ that is designed to fit over a second pipe 28, as illustrated for example in FIG. 3. For example, second inner diameter D₂ may be approximately equal in diameter to the outer diameter of a second pipe 28, such as to provide an interference fit over the second pipe 28 without the need for a fitting to be attached and/or connected to the riser pipe. In exemplary embodiments, second pipe 28 may comprise a standard DWV pipe. Although a DWV pipe is specifically mentioned and described, it is understood that any of a number of pipes may be used in connection with cap 10 without departing from the spirit and scope of the embodiments. In some embodiments, the second portion of cap 10 may be configured for use with 3″, 4″, 6″, and 8″ pipe. Although these dimensions are mentioned in detail, it is understood by those of ordinary skill in the art that any of various dimensions may be used and remain within the spirit and scope of the embodiments. In exemplary embodiments, second inner diameter D₂ may be larger than the diameter of marker 14. Referring again to FIG. 3, in an exemplary embodiment, first inner diameter D₁ may be smaller than the outer diameter of second pipe 28. Accordingly, when cap 10 is placed over pipe 28, the inner surface of cap 10 with first inner diameter D₁ may not engage the outer surface of the pipe 28. Rather, the portion of the cap with first inner diameter D₁ may rest on the top of pipe 28. Accordingly, when cap 10 is placed over a pipe 28 as shown in FIG. 3, marker 14 may be disposed above the opening of pipe 28.

Referring now to FIGS. 4 and 5, as described above, in various exemplary embodiments, marker 14 may be coupled with plate 16 rather than cap 10. In exemplary embodiments, plate 16 may have a diameter D₃ that is greater than the inner diameter of first pipe 26. For example, diameter D₃ may be approximately equal to outer diameter of first pipe 26, such that when plate 16 is placed on top of the opening of first pipe 26, the edges of plate 16 extend to the outer edges of pipe 26, as illustrated in FIG. 5. A conventional cap 30 may also be placed over pipe 26 on top of plate assembly 18 and first pipe 26, as shown. An exemplary first pipe 26 may be a standard sewer pipe, or may be any of a number of pipes, as will be understood.

In exemplary embodiments, the diameter of plate 16 may be configured so that plate assembly 18 may be used with a variety of different size pipes. For example, plate 16 may have a diameter D₃ that is greater than the inner diameter of both first pipe 26 and second pipe 28 (having an inner diameter greater than that of first pipe 26). Referring now to FIGS. 4 and 5, when plate 16 is placed on top of the opening of the first pipe 26 (in FIG. 5), the edges of plate 16 may extend nearly to the outer surface of first pipe 26, but when plate 16 is placed on top of the opening of second pipe 28, the edges of plate 16 may not extend to the outer edges of second pipe 28. The outer diameter of second pipe 28 may be greater than the diameter D₃ of plate 16. A conventional cap 32 may also be placed over pipe 28 on top of plate assembly 18, such as to secure the plate assembly 18 on the end of the pipe. An exemplary second pipe 28 may be a standard DWV pipe, or may be any of a number of pipes, as will be understood.

In exemplary embodiments, the diameter of marker 14 may be less than the diameter of plate 16, and less than first pipe 26 and second pipe 28. In various embodiments, when plate assembly 18 is coupled with either first pipe 26 or second pipe 28, marker 14 may be disposed within pipe 26 or pipe 28, respectively.

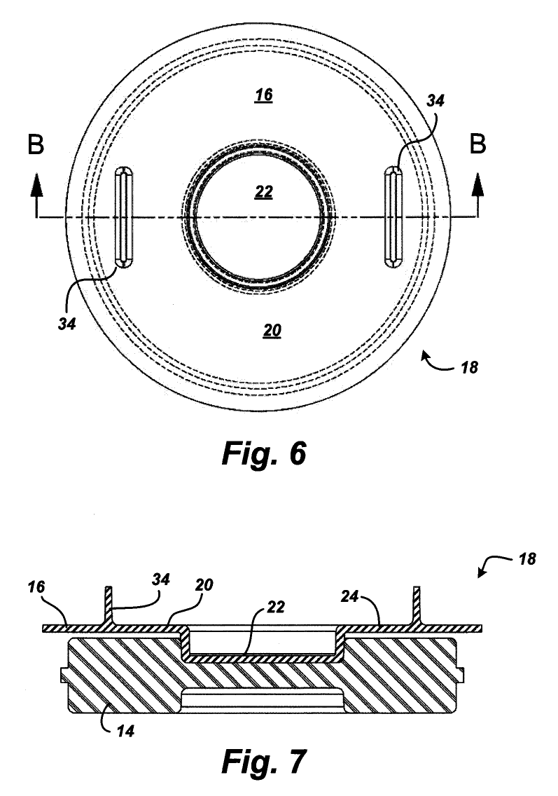

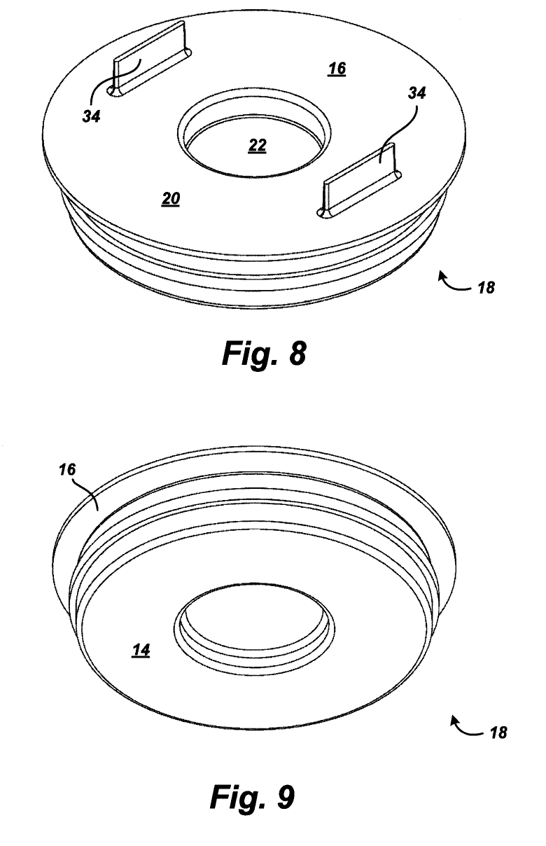

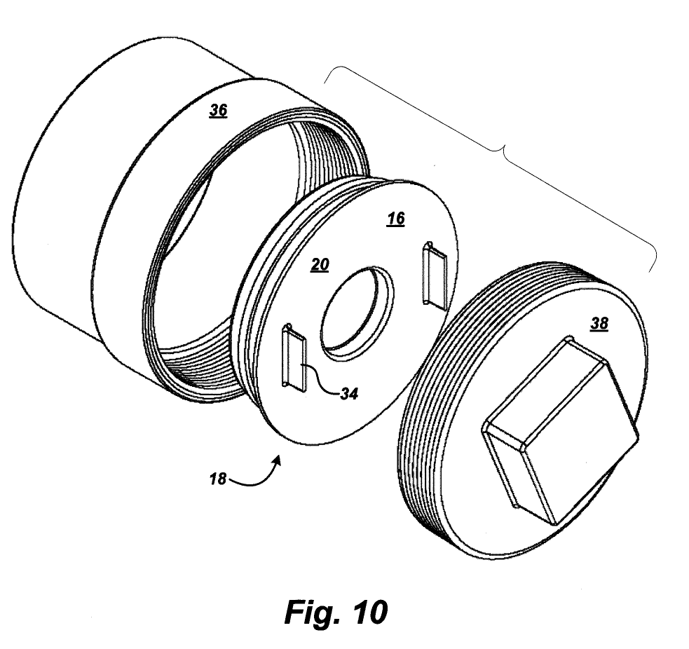

Referring now to FIGS. 6-10, in various exemplary embodiments, plate assembly 18 may be configured to be coupled with a threaded pipe 36. In exemplary embodiments, plate assembly 18 may coupled with threaded pipe 36, so that the plate assembly 18 is inside the pipe. The pipe 36 may have a portion that has an inner diameter less than the diameter D₃ of plate 16, thereby serving as a stop to hold the plate assembly 18 in a predetermined position. As illustrated in FIG. 10, in exemplary embodiments, a threaded plug 38, having threads corresponding to those of pipe 36, may be inserted into the end of pipe 36, and screwed into threaded pipe 36, thereby securing pipe assembly 18, including marker 14, inside pipe 36.

In various exemplary embodiments, one or more features may be provided on the top surface 20 of plate 16, to aid in its insertion and removal from a pipe. For example, as illustrated in FIGS. 6 and 7, plate 16 may have one or more grasping tabs 34 enabling the plate 16 to be easily grasped from its top surface 20. In the exemplary embodiment illustrated in FIGS. 6 and 7, the grasping tabs 34 are generally rectangular flanges, however it is understood that the grasping tabs 34 may have any size or shape suitable for this purpose, without departing from the spirit and scope of the embodiments. Other types of grasping means, such as loops, holes, notches, etc., may be used in addition to, or instead of grasping tabs 34, to assist the removal of the plate assembly 18 from pipe 36. One of ordinary skill in the art would understand how to design and configure such grasping means consistent with the features of the embodiments described herein.

Although particular embodiments have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A cap assembly for placement over an end of at least a first pipe or a second pipe, comprising:
a cap including a first portion having a first inner diameter that is approximately equal to an outer diameter of said first pipe, and a second portion having a second inner diameter that is approximately equal to an outer diameter of said second pipe; and
a top surface configured for coupling with an electronic or magnetic marker.

2. The cap assembly of claim 1 further comprising an electronic or magnetic marker coupled with said top surface of said cap, wherein said marker is coupled to said cap using ultrasonic welding or heat staking.

3. The cap assembly of claim 1 further comprising a third portion having a third inner diameter that is approximately equal to an outer diameter of a third pipe.

4. An assembly for coupling an electronic or magnetic marker with a pipe, comprising:
a plate having an outer diameter that is greater than an inner diameter of said pipe; and
an electronic or magnetic marker coupled with said plate, wherein said electronic or magnetic marker is coupled to said plate using ultrasonic welding or heat staking.

5. The assembly of claim 4, further comprising a cap that covers said plate and said pipe.

6. The assembly of claim 4, further comprising a plug that is configured to be inserted in a threaded portion of said pipe adjacent said plate.

7. The assembly of claim 6, wherein said plug has a threaded outer surface configured to correspond to and engage with a threaded inner surface of said pipe.

8. The assembly of claim 4, wherein said plate further comprises at least one grasping tab.

9. A method for coupling an electronic or magnetic marker to a pipe, comprising:
providing a cap including at least a top portion having a first inner diameter, a bottom portion having a second inner diameter, and an upper surface adjacent to said top portion;
welding or heat-staking an electronic or magnetic marker to said upper surface of said cap; and
placing said cap on an end of a pipe having an outer diameter.

10. The method of claim 9, wherein said first inner diameter is approximately equal to said outer diameter of said pipe, such that placing said cap on said end of said pipe comprises engaging the outer surface of said pipe with an inner surface of said top portion of said cap.

11. The method of claim 9, wherein said second inner diameter is approximately equal to said outer diameter of said pipe, such that placing said cap on said end of said pipe comprises engaging the outer surface of said pipe with an inner surface of said bottom portion of said cap.

12. A method for coupling an electronic or magnetic marker to a pipe, comprising:
providing a plate having an outer diameter that is greater than an inner diameter of a pipe;
welding or heat staking an electronic or magnetic marker to one surface of said plate;
placing the plate adjacent an end of said pipe.

13. The method of claim 12, further comprising:
placing a pipe cap over at least a portion of said plate and over at least a portion of said pipe.

14. The method of claim 12, further comprising:
inserting a plug into a threaded portion of said pipe adjacent said plate.

15. The method of claim 14, wherein said plug has a threaded outer surface configured to correspond to a threaded inner surface of said pipe, and inserting said plug into said pipe comprises engaging the corresponding threaded portions of said pipe and said plug.
